(19) United States
(12) Patent Application Publication
(10) Pub. No.: US 2008/0223412 A1
(43) Pub. Date: Sep. 18, 2008

(54) Substrate support member and apparatus and method for treating substrate with the same

(76) Inventors: Taek-Youb Lee, Chungcheonggi-do (KR); Bong-Joo Kim, Chungcheonggi-do (KR)

Correspondence Address: JENKINS, WILSON, TAYLOR & HUNT, P. A., Suite 1200 UNIVERSITY TOWER, 3100 TOWER BLVD.,, DURHAM, NC, 27707, US

(21) Appl. No.: 12/004,504

(22) Filed: Dec. 20, 2007

(30) Foreign Application Priority Data
Dec. 27, 2006 (KR) 2006-135283

(51) Int. Cl. B08B 3/10

(52) U.S. Cl. 134/33; 134/138; 134/32

(57) ABSTRACT

A substrate support unit supplies a swirl flow to a substrate to rotate and float the substrate from a chuck plate during a process. A process is performed while rotating and floating the substrate. Thus, the substrate is supported and rotates at a process speed while floating form the chuck plate with a non-contact manner.

### CROSS-REFERENCE TO RELATED APPLICATIONS

This U.S. non-provisional patent application claims priority under 35 U.S.C § 119 of Korean Patent Application 2006-135283 filed on Dec. 27, 2006, the entirety of which is hereby incorporated by reference.

### BACKGROUND

The present invention relates to apparatuses and methods for treating substrates. More specifically, the present invention is directed to a substrate support member and apparatus and method for treating a substrate with the substrate support member.

Typical substrate treating apparatuses are used to treat substrates such as a wafer for manufacturing semiconductor integrated circuit (IC) chips, a glass substrate for manufacturing a flat panel display or the like. In such a substrate treating apparatus, a process is performed while a substrate is loaded on a substrate support member. Generally, the substrate support member supports a substrate by means of a mechanical clamp or an electrostatic force or an adsorption force caused by vacuum during a process and rotates a substrate during a process.

A substrate support member includes a chuck plate on which a wafer is loaded during a process and chucking pins for chucking the edge of the wafer to prevent the wafer W from departing from the chuck plate.

However, since a typical substrate support member performs a process while chemically holding a wafer after loading the wafer on a chuck plate, the wafer is contaminated or damaged at a portion which is in mechanical contact with the wafer by holding means. For example, a spin cleaner, a spin etcher, a photoresist coater, and a wafer bevel etcher perform a process while rotating a wafer. Since these apparatuses perform a process while rotating a wafer held by the holding means, contamination and scratch occur at a wafer surface which is in contact with the holding means. Furthermore, since these apparatuses rotate a substrate by means of a mechanical assembly such as a motor, contaminants such as particles are produced by mechanical driving. These contaminants contaminate a wafer and an apparatus to decrease process yield. When a wafer is supported by an electrostatic force or vacuum, a rear surface of the wafer adheres closely to a chuck plate. Thus, the rear surface of the wafer cannot be cleaned or etched.

### SUMMARY OF THE INVENTION

Exemplary embodiments of the present invention are directed to a substrate support unit. In an exemplary embodiment, the substrate treating unit may include: a chuck plate; and a swirl flow supply member for supplying a swirl flow to a substrate surface that is opposite to the chuck plate to float a substrate from the chuck plate.

Exemplary embodiments of the present invention are directed to an apparatus for treating substrates. In an exemplary embodiment, the apparatus may include: a cup in which defined is a space where a process is performed; a substrate support unit including a chuck plate disposed inside the cup; and a treating fluid supply member configured to supply a treating fluid to a substrate that is opposite to the chuck plate during a process, wherein the substrate support unit includes a swirl flow supply member for supplying a swirl flow to a substrate surface that is opposite to the chuck plate to float the substrate from the chuck plate.

Exemplary embodiments of the present invention are directed to a method for treating substrates. In an exemplary embodiment, the method may include: performing a process for a substrate while the substrate is supported, wherein the supporting the substrate is done by supplying a swirl flow to a bottom surface of the substrate to float the substrate.

### BRIEF DESCRIPTION OF THE DRAWINGS

FIG. 1 is a perspective view of a substrate treating apparatus according to an embodiment of the present invention.

FIG. 2 is an internal configuration diagram of the substrate treating apparatus illustrated in FIG. 1.

FIG. 3 is an internal configuration diagram of a substrate treating apparatus according to another embodiment of the present invention.

FIG. 4 is a cross-sectional view of a substrate support member illustrated in FIG. 2.

FIG. 5 is a perspective view of the substrate support member illustrated in FIG. 4.

FIG. 6 is a cross-sectional view, taken along the line A-A′ of FIG. 4, illustrating an example of a swirl flow generation member.

FIGS. 7 through 11 are cross-sectional views illustrating other examples of a swirl flow generator, respectively.

FIGS. 12 and 13 are cross-sectional view illustrating another example of the substrate support member illustrated in FIG. 4.

FIGS. 14 and 15 illustrate still another example of the substrate support member illustrated in FIG. 4.

FIG. 16 illustrates another example of a substrate support member.

FIG. 17 is a cross-sectional view illustrating a substrate treating method according to the present invention.

FIG. 18 is a cross-sectional view taken along the line C-C′ of FIG. 17.

FIGS. 19 and 20 illustrate the flow of a swirl flow supplied from a swirl flow supply member according to the present invention.

FIG. 21 illustrates the generation of a swirl flow inside a swirl flow generation body according to the present invention.

### DETAILED DESCRIPTION OF PREFERRED EMBODIMENTS

The present invention will now be described more fully hereinafter with reference to the accompanying drawings, in which preferred embodiments of the invention are shown. This invention, however, may be embodied in many different forms and should not be construed as limited to the embodiments set forth herein. Rather, these embodiments are provided so that this disclosure will be thorough and complete, and will fully convey the scope of the invention to those skilled in the art. While embodiments of the present invention will be described with respect to a semiconductor manufacturing apparatus configured to perform a wet etch for a semiconductor wafer, the invention may be applied to all apparatuses for treating substrates.

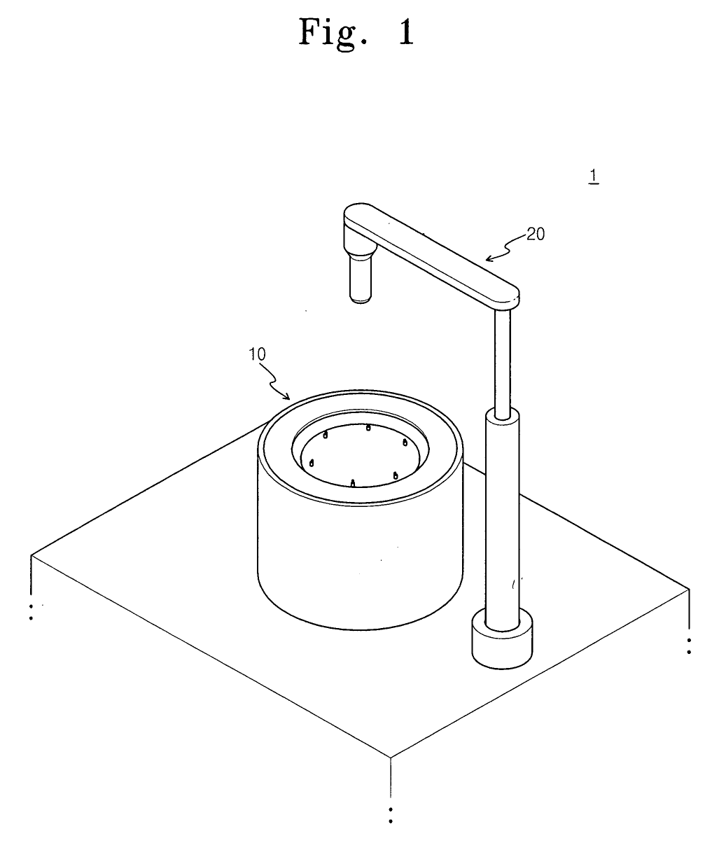

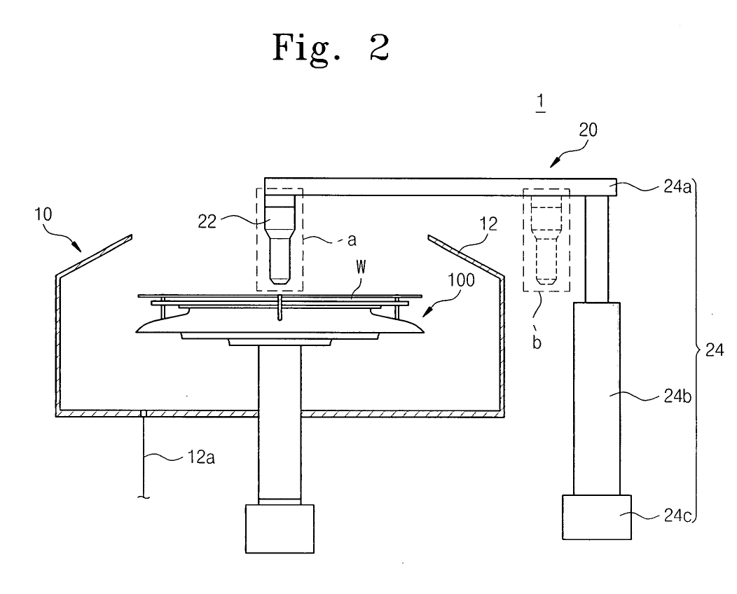

FIG. 1 is a perspective view of a substrate treating apparatus according to an embodiment of the present invention, and FIG. 2 is an internal configuration diagram of the substrate treating apparatus illustrated in FIG. 1.

Referring to FIGS. 1 and 2, an apparatus 1 for treating substrates includes a process treating member 10 and a treating fluid supply member 20. The process treating member 10 is configured to treat a substrate (hereinafter referred to as “wafer”) by means of single-wafer processing. For example, the substrate treating process may be a coating process in which photoresist is coated on a wafer surface, etching and cleaning process in which unwanted foreign materials on a wafer surface are removed, or a bevel etching process in which an edge portion of a wafer is etched.

The treating fluid supply member 20 is configured to supply a treating fluid used in a process. The treating fluid may be various kinds of chemicals, an organic solvent or a treating gas. For example, the treating fluid may be photoresist, etcher (or stripper), a treating solution such as cleaning liquid, inert gas or a treating gas such as dry gas.

The process treating member 10 includes a cup 12 and a substrate support member 100. The cup 12 defines a space in which a wafer treating process is to be performed. The cup 12 exhibits the shape of top-open cylinder. The open top of the cup 12 is used as an entrance through which a wafer W is put in the space or taken out of the space. The substrate support member 100 is configured to support and rotate a wafer W inside the cup 1 during a process. A drain line 12a is connected to the bottom of the cup 12. A treating solution used during a process is exhausted along the drain line 12a.

The treating fluid supply member 20 includes a nozzle 22 and a nozzle carrying member 24. The nozzle 22 is configured to inject the treating fluid to a wafer W during a process. The nozzle carrying member 24 is configured to carry the nozzle 22 between a process position “a” and a wait position “b”. The process position “a” is a position where the nozzle 22 injects a treating fluid to a treating surface of a wafer W, and the wait position “b” is a position where the nozzle 22 waits at the outside of the cup 12 before moving to the process position “a”. The nozzle carrying member 24 includes a first arm 24a, a second arm 24b, and a driver 24c. Each of the first and second arms 24a and 24b exhibits the shape of bar. The first arm 24a is horizontally installed over the cup 12, and the second arm 24b is vertically installed from a side portion of the cup 12. The nozzle 22 is coupled to one end of the first arm 24a, and the second arm 24b is axially coupled to the other end thereof. The driver 24c allows the first and second arms 24a and 24b to operate organically, moving the nozzle 22 between the process position “a” and the wait position “b”.

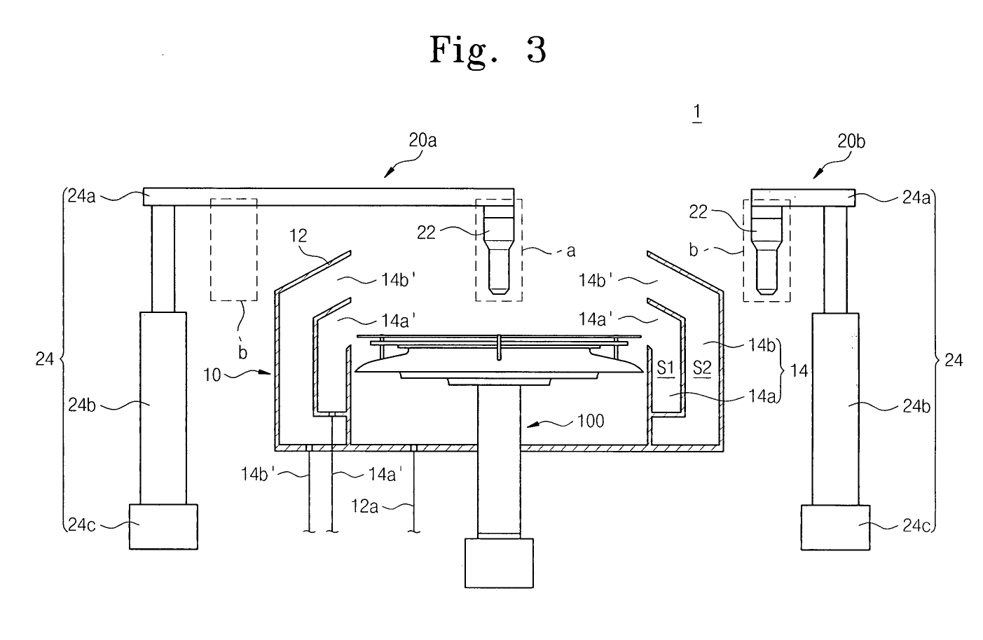

While this embodiment is characterized in that an apparatus 1 for treating substrates includes a cup 12 and one treating fluid supply member 20, the configuration and structure of the apparatus 1 may be modified and changed variously. For example, FIG. 3 illustrates a substrate treating apparatus 1′ according to another embodiment of the present invention. The apparatus 1′ includes a process treating member 10 further including a recovering member 14 and a plurality of treating fluid supply members 20a and 20b. The recovering member 14 is configured to recover a treating solution used in a process. The recovering member 14 includes a first recovering tank 14a and a second recovering tank 14b, which are annularly provided to surround a substrate support member 100 inside the cup 20. A space S1 is defined in the first recovering tank 14a, and a space S2 is defined in the second recovering tank 14b. A first treating solution is contained in the space S1, and a second treating solution is contained in the space S2. An opening 14a′ is formed at the first recovering tank 14a, and an opening 14b′ is formed at the second recovering tank 14b. The first treating solution used in a process flows into the first tank 14a through the opening 14a′, and the second treating solution used in the process flows into the second tank 14b through the opening 14b′. Each opening 14b′ and opening 14a′ are disposed up and down relative to each other. A first recovering line 14a″ is connected to the first recovering tank 14a, and a second recovering line 14b″ is connected to the second recovering tank 14b. The first treating solution contained in the space S1 is recovered along the first recovering line 14a″, and the second treating solution contained in the space S2 is recovered along the second recovering line 14b″. Each of the treating fluid supply members 20a and 20b has the same configuration as the above-described treating fluid supply member 20. The treating fluid supply unit 20a is configured to inject the first treating solution, and the treating fluid supply member 20b is configured to inject the second treating solution. For example, the first treating solution is a cleaning solution to remove foreign materials remaining on the surface of a wafer W and the second treating solution is a rinse solution to remove the cleaning solution remaining on the surface of the wafer W.

The foregoing apparatus 1′ is configured to separately recover a first treating solution and a second treating solution used in a process. That is, the first treating solution injected by a treating fluid supply member 20′ s is dispersed from a wafer W due to the centrifugal force of the wafer W to be contained in the space S1 of the first recovering tank 14a. By the same manner, the second treating solution injected by a treating fluid supply member 20″ is contained in the space S2 of the second recovering tank 14b. A substrate support unit 100 travels to a position corresponding to the opening 14a′ or 14b′ according to the process to recover the first and second treating solutions used in the process to the space S1 or S2. Thus, the first and second treating solutions used in the process are independently recovered.

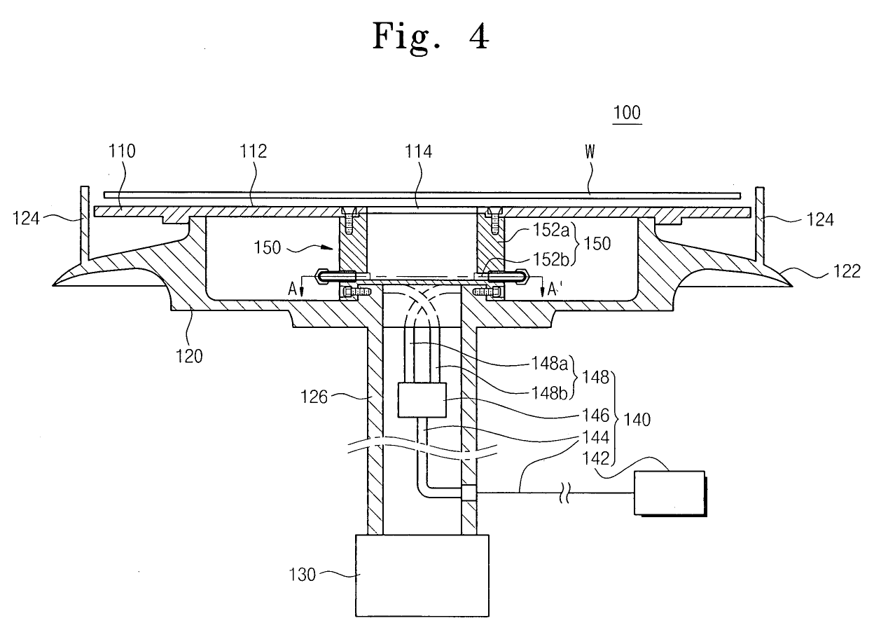

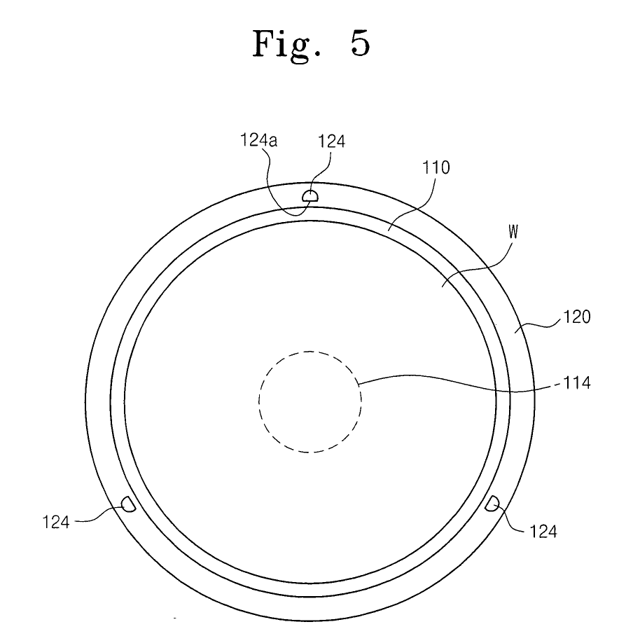

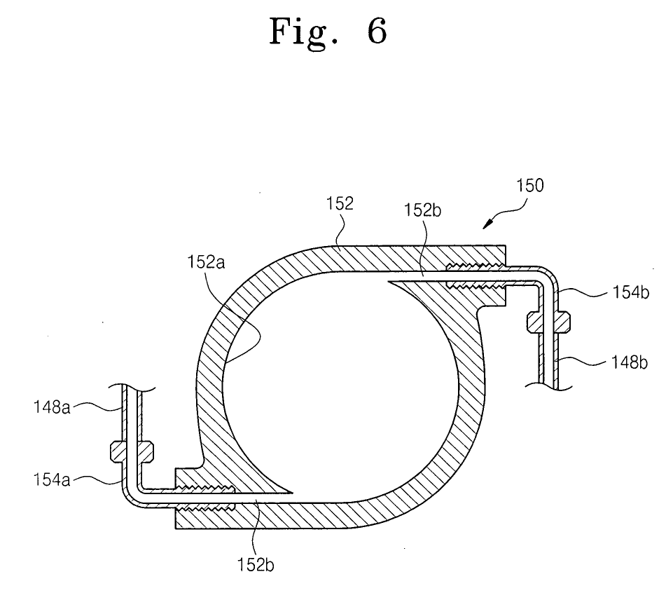

The configuration of the substrate support unit 100 will now be described below in detail. FIG. 4 is a cross-sectional view of a substrate support member illustrated in FIG. 2, and FIG. 5 is a perspective view of the substrate support member illustrated in FIG. 4. FIG. 6 is a cross-sectional view, taken along the line A-A′ of FIG. 4, illustrating an example of a swirl flow generation member.

Referring to FIGS. 4 through 6, a substrate support unit 100 includes a chuck plate 110, a base 120, a driving member 130, and a swirl flow supply member. The chuck plate 110 roughly exhibits of a disk. The chuck plate 110 has a top surface 112 that is opposite to a wafer W during a process. An opening 114 is formed at the center of the chuck plate 110. The opening 114 is a hole through which a swirl flow is injected during a process.

The base 120 is coupled with the bottom of the chuck plate 110 to support the chuck plate 110 and exhibits the shape of a disk having a larger diameter than the chuck plate 110. Since the base 120 is downwardly inclined to the edge from the center, a treating solution dropping on the base 120 during a process flows downwardly along an inclined surface formed at the edge of the base 120. A plurality of side guide pins 124 are provided at the base 120 to prevent a wafer W from laterally departing from the chuck plate 110. The inner side surface of the side guide pin 124 is rounded to correspond to the side surface of a wafer W and provided to suppress the scratch on the side surface of a wafer W even when the wafer W comes in contact with the inner side surface 124a. The side guide pins 124 are disposed to be wider than the diameter of a wafer W such that they are not in contact with the side surface of the wafer W during a process. Thus, the wafer W is not in contact with the side guide pins 124 during a process and the movement of the wafer W is limited in the case where the wafer W departs from a preset process position of the chuck plate 110. A support shaft 126 is coupled with the central bottom of the base 120 to support the base 120. The support shaft 126 is disposed to penetrate the center of a bottom surface of the cup 12.

The driving member 130 is configured to elevate or lower the chuck plate 110 and the base 120. The driving member 130 is coupled with the support shaft 126 of the base 10. The driving member 130 elevates and lowers the support shaft 126 to adjust height of a wafer W supported by the chuck plate 110. That is, the driving member 130 elevates the chuck plate 110 to expose the top surface of the chuck plate 110 to the outside through the open top of the cup 12 when the wafer W is loaded and unloaded and lowers the elevated chuck plate 110 into the cup 12 when the wafer W is cleaned.

The swirl flow supply member is configured to supply a swirl flow to a wafer side facing the chuck plate 110 during a process. The swirl flow supply member includes a gas supply member 140 and a swirl flow generation body 150. The gas supply member 140 includes a gas supply source 142 and a gas supply line. The gas supply line includes a main supply line 144, a manifold 146, and a plurality of injection lines 148. The injection lines 148 include a first injection line 148a and a second injection line 148b. The main supply line 144 is configured to supply a gas to the manifold 146 from the gas supply source 142. A flow control member 144a is installed at the main supply line 144 to control a flow rate of the gas supplied through the main supply line 144. The flow control member 144a may be a mass flowmeter controller (MFC). The manifold 146 is configured to uniformly distribute the supplied gas to the respective injection lines 148a and 148b. The injection lines 148 are configured to supply the gas distributed by the manifold 146 to the swirl flow generation body 150. One end of the injection lines 148 is connected to the manifold 146, and the other end thereof is connected to the swirl flow generation body 150. In an exemplary embodiment, the other end of the respective injection lines 148a and 148b is connected to the side bottom of the swirl flow generation body 150. Around a housing 152, the respective injection lines 148a and 148b are disposed along a side surface of the housing 152 at regular angles. The injection line 148 is configured to supply a gas to a gas inflow hole 152a of the swirl flow generation body 150. The inflow hole 152a will be described later.

The swirl flow generation body 150 receives a gas from the injection lines 148 to generate a swirl flow. The swirl flow generation body 150 includes a barrel-shaped housing 152 disposed at the bottom center of the chuck plate 110. The housing 152 has an open top connected to the opening 114 of the chuck plate 110. A cylindrical space is defined inside the housing 150. A gas inflow hole 152b is formed at the hosing 150. The gas supplied along the injection lines 148a and 148b flows into the housing 150 through the gas inflow hole 152b. The gas inflow hole 152b allows the gas supplied along the injection lines 148 to flow in a tangent line of the inner side surface 152a of the housing 150. A plurality of gas inflow holes 152b are provided around the housing 152 at regular spaces. The gas flow hole 152b allows a gas to be supplied horizontally. Connecting means 154 is provided at the gas inflow hole 152b for connecting the gas inflow hole 152b to the injection line 148. The connecting means 154 may be a union or a connecter. The above-described swirl flow generation body 154 receives a gas from the gas supply member 140 to generate a swirl flow during a process. The generated swirl flow is injected to a bottom surface of a substrate W, making the substrate W float from a top surface 112 of the chuck plate 110. The floating substrate W rotates due to the swirl flow.

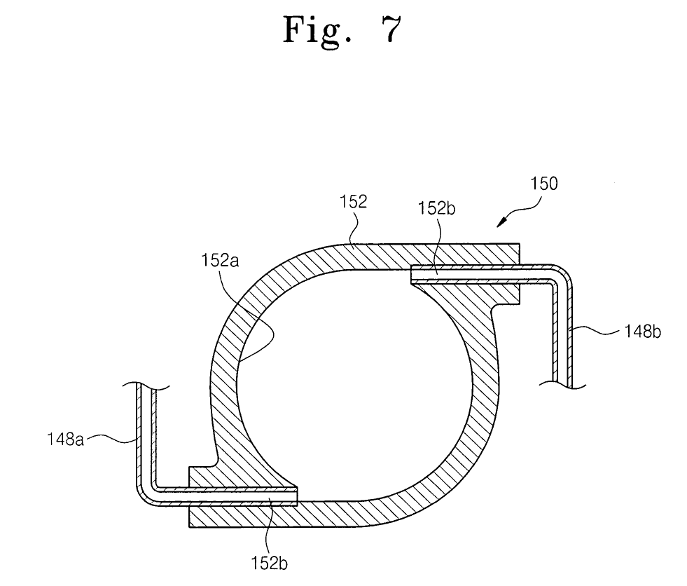

While this embodiment is characterized in that the gas inflow hole 152b is provided at the swirl flow generation body 150 to allow a gas to flow in a tangent line of the inner side surface of the swirl flow generation body 150, injection lines 148a and 148b may extend to the inner side surface of a direct swirl flow generation body 150 to inject a gas in a tangent line direction of the inner side surface of the swirl flow generation body 150, as illustrated in FIG. 7B.

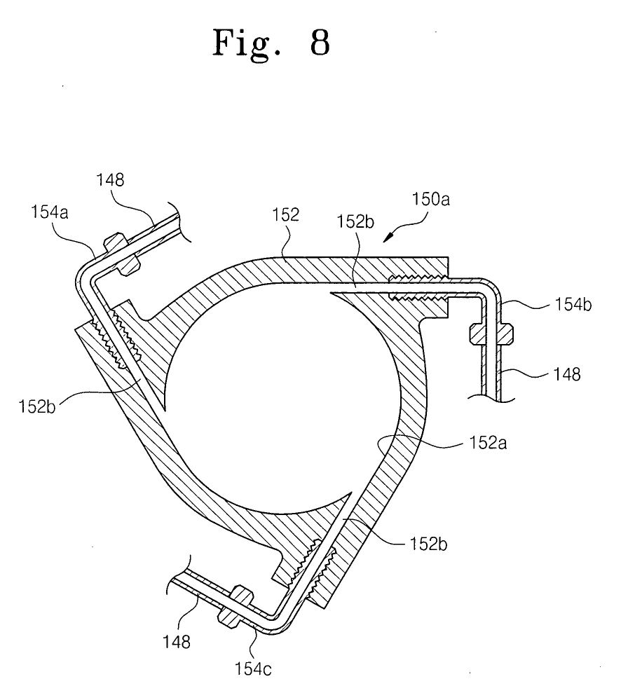

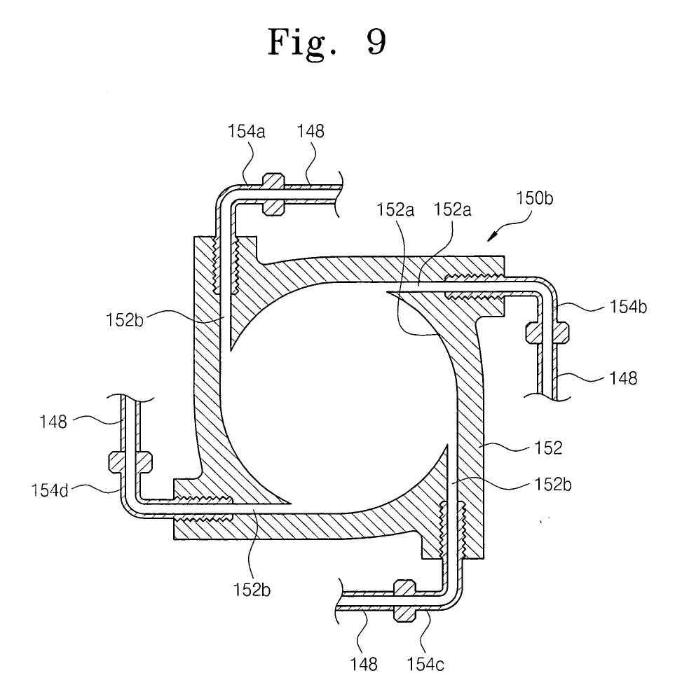

While FIG. 6 illustrates a swirl flow generation member receiving a gas from two injection lines 148a and 148b to generate a swirl flow, one injection line or at least three injection lines may be provided for supplying a gas to a swirl flow generation member. For example, a swirl flow supply member illustrated in FIG. 8 receives a gas from three injection lines 148a, 148b, and 148c to generate a swirl flow. Alternatively, a swirl flow supply member illustrated in FIG. 9 receives four injection lines 148a, 148b, 148c, and 148d to generate a swirl flow.

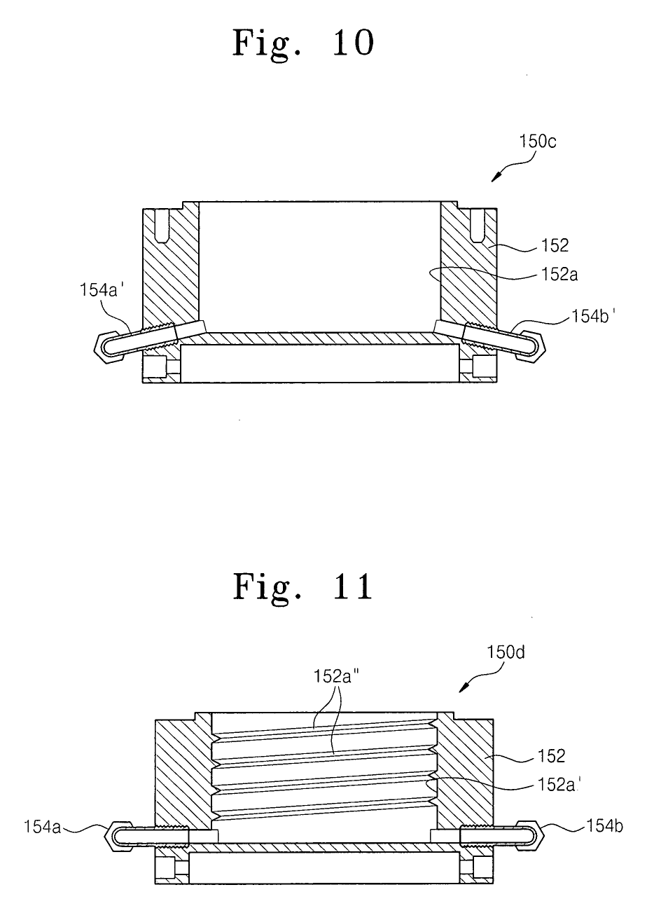

Furthermore, while this embodiment is characterized in that the injection line 148 and the gas inflow hole 152b are provided to horizontally supply a gas into the housing 152, a supply angle of the gas may be varied. For example, a swirl flow supply member 150c illustrated in FIG. 10 is provided with an injection line 148 and a gas inflow hole 152b to allow a gas to be supplied upwardly toward the inside of a swirl flow generation body 150. The swirl flow generation member 150c is configured to generate a swirl flow where a gas supplied to the housing 152 has a larger ascending current than in the swirl flow generation body 150 illustrated in FIG. 2.

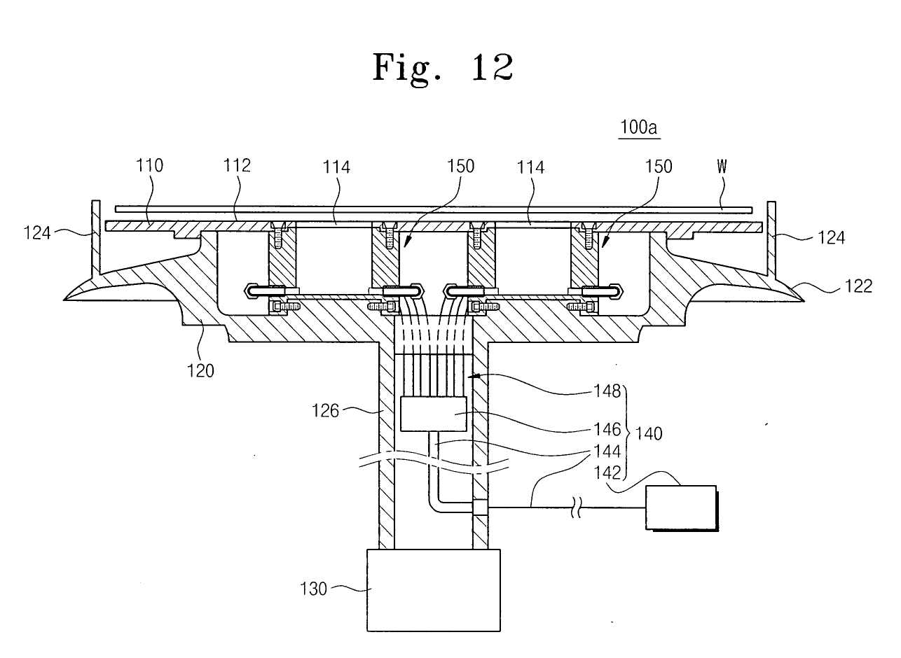

Furthermore, while this embodiment is characterized in that the swirl flow generation body 150 has a cylindrical inner side surface 152, the inner side surface 152 of the housing 150 may have various changes and modifications. In addition, a screwthread-type groove 152a′ may be provided at the inner side surface of a swirl flow generation body 150 according to another embodiment of the present invention, as illustrated in FIG. 11.

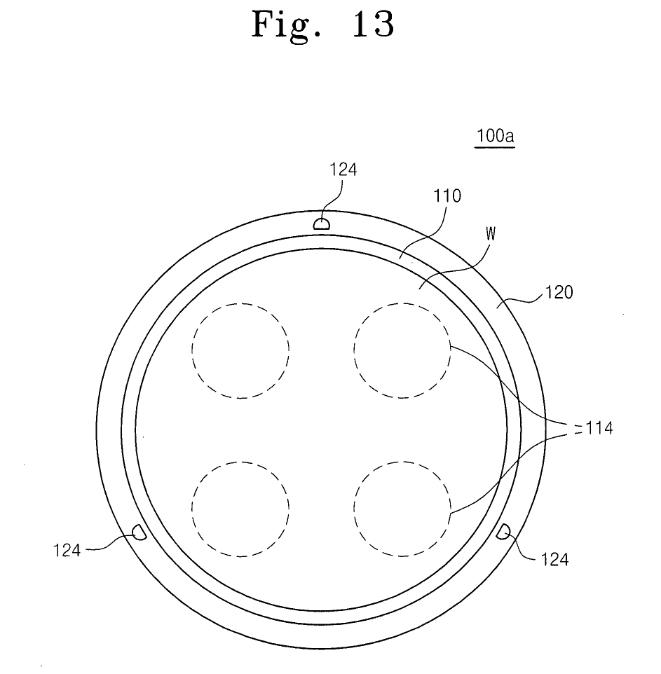

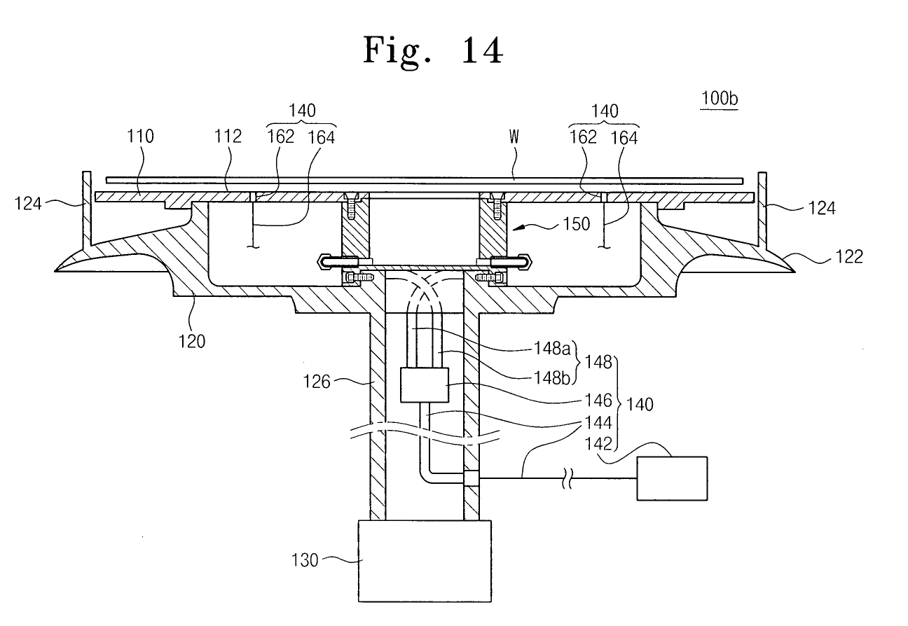

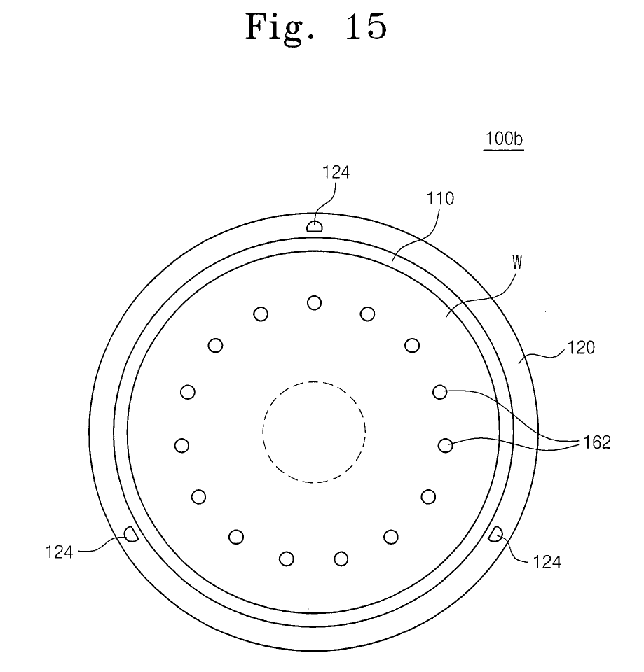

Furthermore, while this embodiment is characterized in that one swirl flow generation body 150 is disposed at the center of the chuck plate 110, the swirl flow generation body 150 may change in position and number. For example, a substrate support unit 100a illustrated in FIGS. 12 and 13 may include four swirl flow generation bodies 150 which are arranged around a chuck plate 110 at regular intervals.

Furthermore, while this embodiment is characterized in that a wafer W is floated only by a swirl flow supplied by one swirl flow generation member, means for auxiliarily floating a wafer W may be further provided at a substrate support unit. For example, auxiliary floating means 160 may be provided at a substrate support unit 110b to inject a gas toward the bottom surface of a wafer W during a process. The auxiliary floating means 160 includes injection holes 162 formed at a chuck plate 110 and a gas supply line 164 along which a gas is supplied to the injection holes 162. The injection holes 162 are disposed to surround an opening 110 of the chuck plate 110. The injection holes 162 may change in shape and size. The gas supply line 164 is configured to supply a gas to the respective injection holes 162. The gas supplied along the gas supply line 164 is injected to the bottom surface of a wafer W to float the wafer W. Accordingly, the substrate support unit 100b may float a wafer W using a swirl flow supply member as well as a gas injection member 160. As a result, a wafer W may float more efficiently.

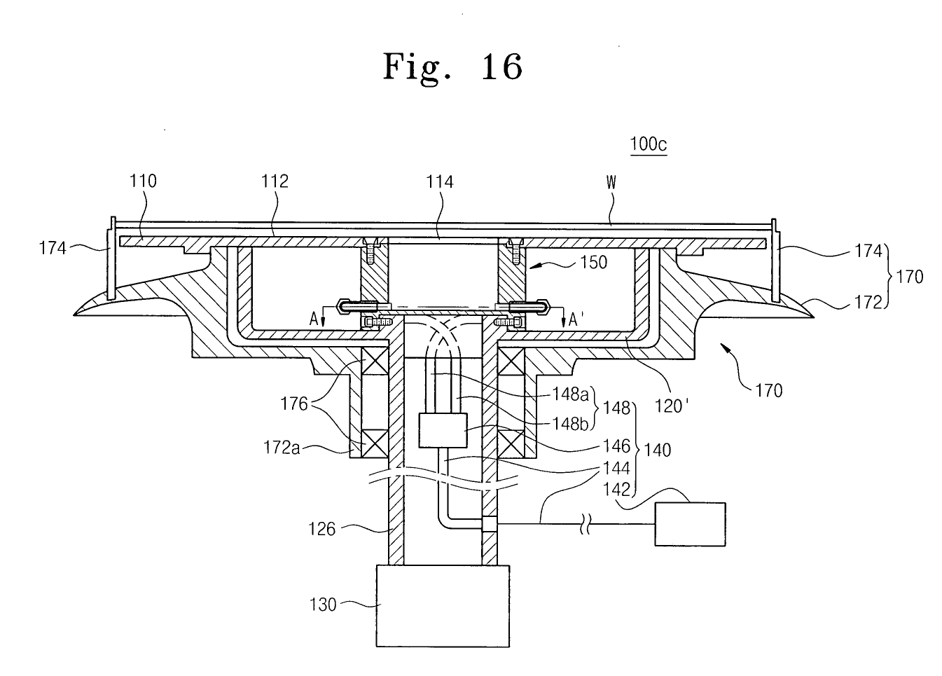

Furthermore, while this embodiment is characterized in that a wafer W rotates only using a swirl flow supplied by a swirl flow generation member, means for auxiliarily rotating a wafer W using a swirl flow may be provided at a substrate support unit. For example, a substrate support unit illustrated in FIG. 16 further includes auxiliary rotation means 170. The auxiliary rotation means 170 includes a rotation body 172 and chucking pins 174. The rotation body 172 is manufactured to be roughly ring-shaped and installed to surround a base 120′. A rotation shaft 172a is provided at the center of the rotation body 172 and installed on a support shaft 126 of the base 120′ to be rotatable from the outside of the support shaft 126. Bearings 176 are provided between the rotation shaft 172a and the support shaft 126. The rotation body 172 rotates by means of a rotation motor (not shown). Chucking pins 174 are installed at the edge of the rotation body 172 to chuck a portion of the edge of the wafer W supported on a chuck plate 110 during a process.

The auxiliary rotation means 170 mechanically rotates a wafer W using a rotation motor during a process. Thus, the substrate support unit 100c may rotate a wafer W using a swirl flow supply member as well as the auxiliary rotation means 170. As a result, the wafer W may rotate more efficiently. Especially, the above-described substrate support unit 100c may selectively rotate a wafer W using a swirl flow supply member or an auxiliary rotation means 170 during a process. That is, a wafer W rotates by supplying a swirl flow in a process requiring a low speed rotation of the wafer W and rotates using the auxiliary rotation means 170 in a process requiring a high speed rotation of the wafer W. For example, a typical wafer cleaning process includes a chemical cleaning process in which a wafer W is cleaned using a chemical and a wafer drying process in which the cleaned wafer W is dried using a dry gas, which are successively carried out. The wafer W rotates at a high speed during the drying process and at a relatively low speed during the cleaning process. Thus, a wafer W may rotate using the swirl flow supply member during a chemical cleaning process and may rotate using auxiliary rotation means 170 during a drying process.

The process treatment of an apparatus 1 for treating substrates according to the present invention will now be described below in detail. The same elements are designated by the same reference numerals and will not be described in further detail.

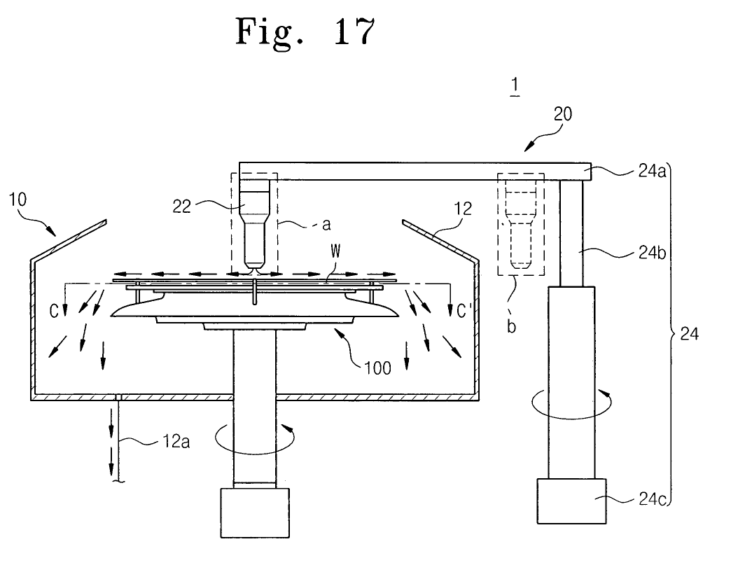

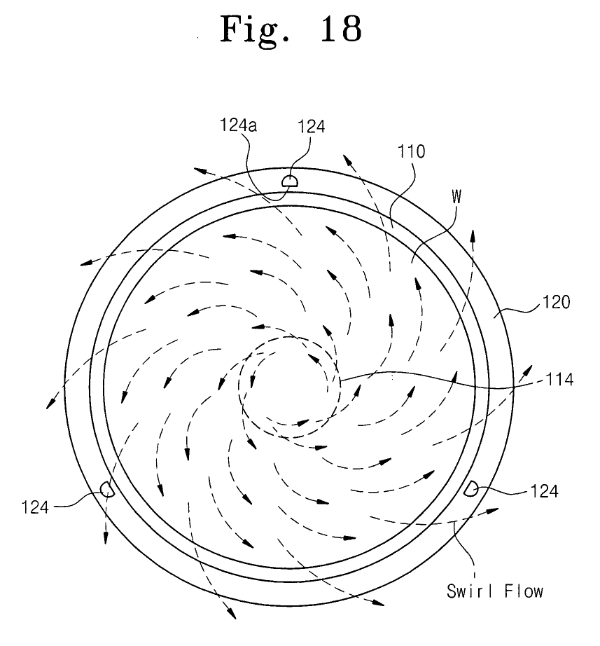

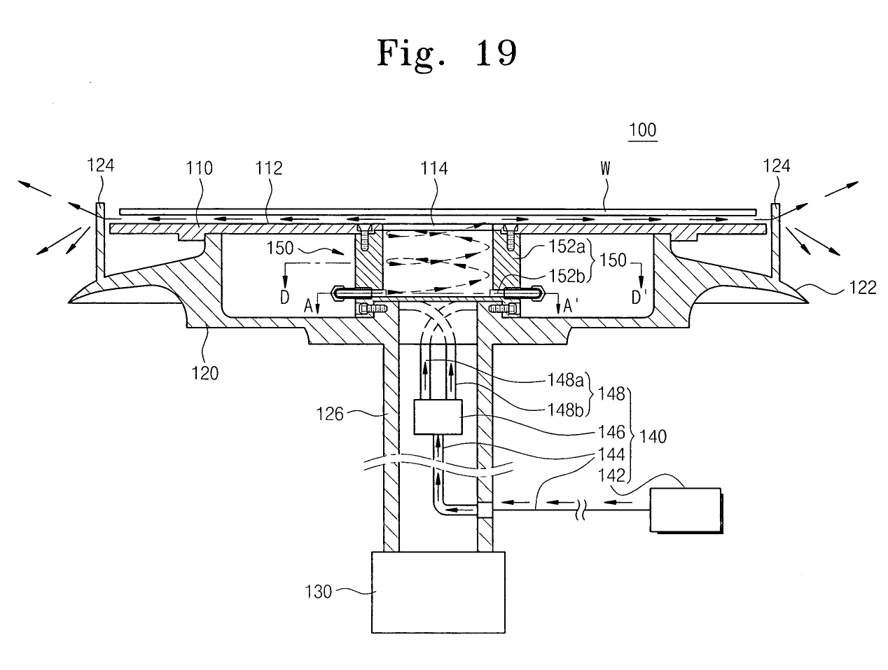

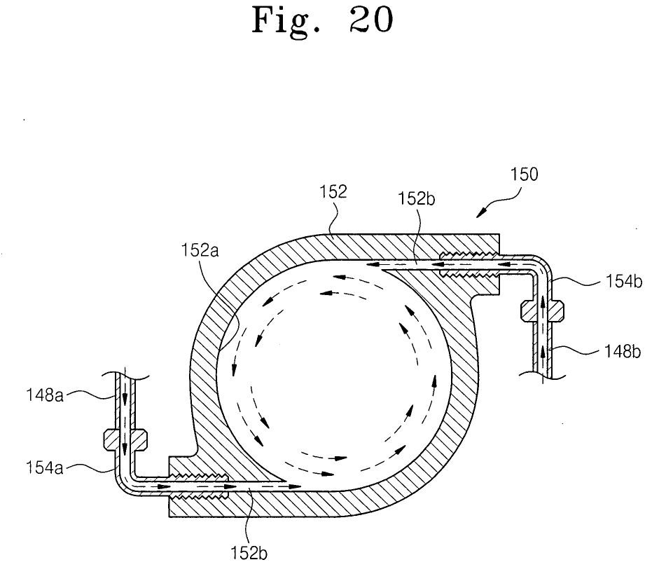

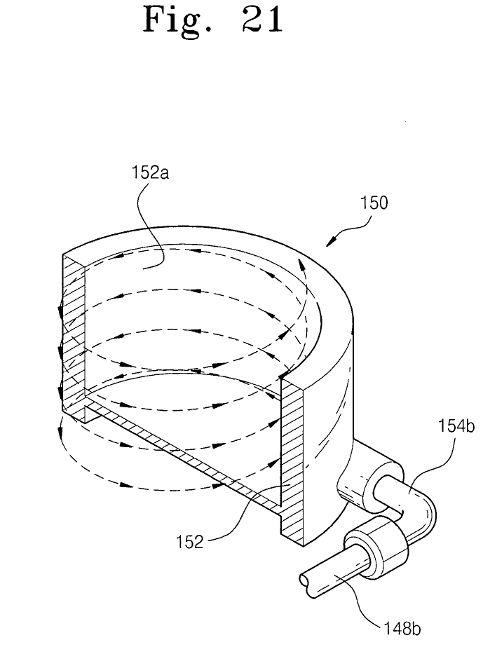

FIG. 17 is a cross-sectional view illustrating a substrate treating method according to the present invention, and FIG. 18 is a cross-sectional view taken along the line C-C′ of FIG. 17. FIG. 19 illustrates the flow of a swirl flow supplied from a swirl flow supply member according to the present invention, and FIG. 20 is a cross-sectional view taken along the line D-D′ of FIG. 19. FIG. 21 illustrates the generation of a swirl flow inside a swirl flow generation body according to the present invention.

Referring to FIGS. 17 and 18, when a process starts, a wafer W is loaded on a chuck plate 110 of a substrate support unit 100. A swirl flow supply member supplies a swirl flow to a wafer surface, which is opposite to a top surface 112 of the chuck plate 110, through an opening 114 formed at the chuck plate 110. That is, referring to FIGS. 19 and 20, a mechanical supply line 140 supplies a gas to a swirl flow generation body 150. At this point, a flow control member 144a controls a gas flowing inside a main supply line 144 in advance to be supplied at a preset flow rate. The gas injected into a housing 152 of the swirl flow generation body 150 generates a swirl flow while swirling along the inner side surface 152a of the housing 152. The generated swirl flow is injected through the opening 114 of the chuck plate 110 to be supplied to a central portion of the wafer W.

The swirl flow supplied to the wafer W floats the wafer W from the top surface 112 of the chuck plate 110. The floating wafer W is supported over the chuck plate 110 by the swirl flow exhausted through the space “c” between a bottom surface of the wafer W and the top surface 112 of the chuck plate 110. That is, an inner pressure of the space “c” rises due to the swirl flow exhausted through the space “c” to enable the wafer W to be tightly supported over the chuck plate by Bernoulli effect. Before the wafer W is loaded on the chuck plate 110, the swirl flow is supplied to float the wafer W. Alternatively, after the wafer W is loaded on the top surface 112 of the chuck plate 110, the swirl flow may be supplied to float the wafer W.

The wafer W rotates using the supplied swirl flow at a preset process rotation speed. That is, as the swirl flow supplied to the center of the wafer W swirlingly migrates to the edge from the center of the space “c, the wafer W rotates. The rotation speed of the wafer W is controlled depending on the amount of a swirl flow supplied from a swirl flow supply member. That is, a flow control member 144a of the swirl flow supply member controls a flow rate of the gas in a main supply line 144 to set the rotation speed of the wafer W to a preset rotation speed. In the flow rate control done by the flow control member 144a, a value is set to supply a gas at a preset flow rate before a process is carried out. Alternatively, a rotation speed of a wafer W is sensed in real time to control a flow rate of the gas in the main supply line 144 such that the rotation speed of the wafer W meets a preset speed.

If the wafer W rotates at the preset process speed, a treating fluid supply member 20 supplies a treating solution to a treating surface of the rotating wafer W. That is, a nozzle carrying member of the treating fluid supply member 20 carries a nozzle 22 to a process position “a” from a waiting position “b”. When the nozzle 22 is disposed at the process position “a”, the nozzle 22 supplies the treating solution to the treating surface of the wafer W. The treating solution is drained through a drain line 12a of a cup 12 after being supplied to treat the surface of the wafer W. The treated wafer W is pulled out to the outside of the cup 12 after being unloaded from a substrate support unit 100.

As described above, a swirl flow is supplied to a wafer W to float and rotate the wafer W during a process. The wafer W is treated without being in contact with wafer supporting means such as a chuck plate 110 and side guide pins 124 of a substrate support unit 100 during a process. Thus, the wafer W is protected from the damage caused by means that is in contact with the wafer W.

In addition, a wafer W floats from a chuck plate 110 and rotates to treat a wafer surface of the chuck plate 110. For example, a treating gas or a treating solution is supplied to a bottom surface of the floating wafer W to treat the substrate W.

In addition, the supply amount of a swirl flow for floating and rotating a wafer W is controlled. Thus, the supply amount of the swirl flow is controlled depending on process conditions to adjust a floating degree of the wafer W and a rotation speed of the wafer W.

In addition, members for tightly holding and rotating a wafer W are not provided to simplify an apparatus configuration and reduce manufacturing costs.

Although the present invention has been described in connection with the embodiment of the present invention illustrated in the accompanying drawings, it is not limited thereto. It will be apparent to those skilled in the art that various substitutions, modifications and changes may be made without departing from the scope and spirit of the invention.

What is claimed is:

1 . A substrate support unit comprising:
a chuck plate; and
a swirl flow supply member for supplying a swirl flow to a substrate surface that is opposite to the chuck plate to float a substrate from the chuck plate.

2. The substrate support unit of claim 1, wherein the swirl flow supply member comprises:
a barrel-type swirl flow generation body having an open top; and
a gas supply line for injecting a gas into the swirl flow generation body to allow the gas to swirl along an inner side surface of the swirl flow generation body at an inner space of the swirl flow generation body.

3. The substrate support unit of claim 2, wherein the inner space of the swirl flow generation body exhibits a cylindrical shape; and
wherein the gas supply line is configured to supply a gas in a tangent line direction relative to the inner side surface of the swirl flow generation body.

4. The substrate support unit of claim 2, wherein the inner space of the swirl flow generation body exhibits a cylindrical shape; and
wherein the swirl flow generation body includes a gas inflow hole through which a gas inflow is conducted in a tangent line direction relative to the inner side surface of the swirl flow generation body.

5. The substrate support unit of claim 4, wherein the gas supply line includes a plurality of injection lines connected to the swirl flow generation body to rotate in the same direction inside the swirl flow generation body.

6. The substrate support unit of claim 2, further comprising:
a side guide pin provided around the circumference of a substrate loaded on the chuck plate to prevent the substrate from departing from the chuck plate during a process.

7. The substrate support unit of claim 2, wherein the swirl flow generation body is installed at the center of the chuck plate.

8. The substrate support unit of claim 2, further comprising:
a flow control member installed at the gas supply line to control the amount of a gas supplied to the gas supply line.

9. The substrate support unit of claim 1, further comprising:
auxiliary floating means for auxiliarily floating the substrate during a process, wherein the auxiliary floating means includes injection holes and a gas supply line which supplies a gas to the injection hole,
wherein the holes are formed in the chuck plate and inject a gas to the bottom surface of the substrate.

10. The substrate support unit of claim 9, wherein the swirl flow generation body is installed at the center of the chuck plate; and
wherein the injection holes are annularly arranged to surround the open top of the swirl flow generation body.

11. The substrate support unit of claim 1, further comprising:
auxiliary rotation means for auxiliarily rotating the substrate during a process, the auxiliary rotation means including a chuck pins provided to chuck the side surface of the substrate during a process, a rotation body where the chucking pins are installed, and a driving motor configured to rotate the rotation body.

12. The substrate support unit of claim 11, wherein the rotation body is provided to be ring-shaped.

13. An apparatus for treating substrates, comprising:
a cup in which defined is a space where a process is performed;
a substrate support unit including a chuck plate disposed inside the cup; and
a treating fluid supply member configured to supply a treating fluid to a substrate that is opposite to the chuck plate during a process,
wherein the substrate support unit includes a swirl flow supply member for supplying a swirl flow to a substrate surface that is opposite to the chuck plate to float the substrate from the chuck plate.

14. The apparatus of claim 13, wherein the swirl flow supply member comprises:
a barrel-type swirl flow generation body having an open top; and
a gas supply line for injecting a gas into the swirl flow generation body to allow the gas to swirl along an inner side surface of the swirl flow generation body at an inner space of the swirl flow generation body.

15. The apparatus of claim 14, wherein the inner space of the swirl flow generation body exhibits a cylindrical shape; and
wherein the gas supply line is configured to supply a gas in a tangent line direction relative to the inner side surface of the swirl flow generation body.

16. The apparatus of claim 14, wherein the inner space of the swirl flow generation body exhibits a cylindrical shape; and
wherein the swirl flow generation body includes a gas inflow hole through which a gas inflow is conducted in a tangent line direction relative to the inner side surface of the swirl flow generation body.

17. The apparatus of claim 15, wherein the gas supply line includes a plurality of injection lines connected to the swirl flow generation body to rotate in the same direction inside the swirl flow generation body.

18. The apparatus of claim 17, further comprising:
a side guide pin provided around the circumference of a substrate loaded on the chuck plate to prevent the substrate from departing from the chuck plate during a process.

19. The apparatus of claim 14, wherein the swirl flow generation body is installed at the center of the chuck plate.

20. The apparatus of claim 14, further comprising:
a flow control member installed at the gas supply line to control the amount of a gas supplied to the gas supply line.

21. The apparatus of claim 13, further comprising:
auxiliary floating means for auxiliarily floating the substrate during a process, wherein the auxiliary floating means includes injection holes and a gas supply line which supplies a gas to the injection hole,
wherein the holes are formed in the chuck plate and inject a gas to the bottom surface of the substrate.

22. The apparatus of claim 20, wherein the swirl flow generation body is installed at the center of the chuck plate; and
wherein the injection holes are annularly arranged to surround the open top of the swirl flow generation body.

23. The apparatus of claim 13, further comprising:
auxiliary rotation means for auxiliarily rotating the substrate during a process, the auxiliary rotation means including a chuck pins provided to chuck the side surface of the substrate during a process, a rotation body where the chucking pins are installed, and a driving motor configured to rotate the rotation body.

24. The substrate support unit of claim 23, wherein the rotation body is provided to be ring-shaped.

25. A method for treating substrates, comprising:
performing a process for a substrate while the substrate is supported, wherein the supporting the substrate is done by supplying a swirl flow to a bottom surface of the substrate to float the substrate.

26. The method of claim 25, further comprising:
performing a process for a substrate while the substrate rotates using the swirl flow.

27. The method of claim 26, wherein the swirl flow is injected to the center of the substrate.

28. The method of claim 24, wherein the swirl flow is injected to the center of the substrate;
wherein a gas is injected to the substrate to assist the substrate floating conducted using the swirl flow during a process; and
wherein the injection of the gas is conducted at a position surrounding a portion where the swirl flow is injected.

29. The method of claim 24, wherein the substrate rotation conducted using the swirl flow is assisted by means of pins which are in contact with a side surface of the substrate to rotate the substrate.

30. The method of claim 24, wherein the substrate rotation comprises:
supplying the swirl flow to rotate the substrate when a process rotation speed of the substrate is lower than a reference speed; and
mechanically rotating the substrate using a rotation motor when a process rotation speed of the substrate is higher than a reference speed.
